(19) United States
(12) Patent Application Publication
(10) Pub. No.: US 2014/0379434 A1
(43) Pub. Date: Dec. 25, 2014

(54) APPLICATIONS FOR MAKING BREAKTHROUGH DECISIONS AND IMPROVING DECISIONS OVER TIME

(71) Applicant: Willard I. Zangwill, Chicago, IL (US)

(72) Inventor: Willard I. Zangwill, Chicago, IL (US)

(21) Appl. No.: 14/309,377

(22) Filed: Jun. 19, 2014

Related U.S. Application Data
(60) Provisional application No. 61/956,855, filed on Jun. 19, 2013.

(51) Int. Cl. G06Q 10/06

(52) U.S. Cl. CPC G06Q 10/0637
USPC 705/7.36

(57) ABSTRACT

Systems and methods are disclosed to assist in making decisions and in improving decisions with the goal of making exceptionally good decisions, indeed breakthroughs. Systems and methods also adapt and improve over time with experience and usage as users update the information based upon actual situations, thus iterating to better decisions. The system or application includes a repository or collection of decision apps or subprograms where each app is designed to help make a different type of decision. A breakthrough engine uses the apps (and other data) to actually make the decision. In particular, a decision is proposed, and metrics then evaluate the decision. If the decision quality not is exceptionally good, issues are suggested to be examined to improve the decision, and an improved decision is made. If this improved decision is not sufficiently excellent on the metrics, the process is repeated.

### CROSS-REFERENCE TO RELATED APPLICATIONS

This application claims benefit of priority of U.S. Provisional Patent Application 61/956,855, filed Jun. 19, 2013, entitled “Method and System for Making Breakthrough Decisions”, which is incorporated by reference herein in its entirety.

### FIELD

The invention relates to the making of decisions that are exceptionally good, and more particularly where decision making is improved by the use of relevant metrics or measures, including financial valuation.

### BACKGROUND

Decision making is highly complex. Often the goal, objective or purpose of the decision is not clear. Risks, “black swans” and uncertainties intrude. The decision might be made by humans, by computers or other devices or by complex combinations of those. The human decision makers, as behavioral sciences have well documented, are subject to biases and faulty reasoning. By and large, the greater the complexity, the greater the competition, and the greater the number of tasks involved, then the greater the difficulty in making a decision successful. Examples of this are the disappointing success rate of many acquisitions and the frequent cost overruns with large information technology projects. New ventures and new product launches similarly have a high failure rate due to having an abundance of factors whose outcomes are risky and difficult to predict. Political, military decisions and intelligence analyses are also noted and sometimes loudly criticized for their predictive and decision inadequacies.

In many situations, an important metric is the decision's expected financial impact, or its benefit in terms of achieving desired goals or other numerical determination of the decision's value or usefulness. Kesten Green and J. Scott Armstrong developed a methodology that significantly improved predictive accuracy in complex situations. It employed as references other instances similar to the situation being examined. Having those other references for comparison broadened the perspective and significantly improved the accuracy of the forecasts.

Although their work represents an advancement, it raises questions about how much improvement was made, can improvements be made, and is the determined decision good enough?

In particular, the expected financial value of a project, strategy, or activity is an essential number which is critical for evaluating whether to undertake the project or not. Because it is essential, such traditional analyses may be improved in several areas.

First, traditional financial analyses require considerable financial expertise to undertake, and that makes it difficult to obtain a financial value for many projects, despite that information being of singular value and importance.

Second, in most firms, many requests are made to fund projects and activities. Often, however, a number of these requests have highly optimistic financial projections. What is needed is an easy and convenient procedure to explore those projections and to validate their accuracy and realism.

Third, risks are a pervasive difficulty in the approval an undertaking of projects, strategies, and activities. Unless one is highly expert, risks can have a huge and disproportionate impact. To take a simple example, suppose $100 million will become $125 million in a year. That is a 25% ROI. But suppose the probability of that outcome is 80%. Some might assume that the ROI gets reduced to 20% (25×0.8=20). That is incorrect, however, as actually the ROI has plummeted to zero. Hence the aforementioned requirement for expertise.

The financial valuation process has other traps that can cause erroneous results. Here is a very simple example. For an important project, revenues are projected to be 100. (All numbers are in millions). Costs are locked in by contract and sure to be 90. Hence, profits are projected to be 10.

However, revenues are difficult to predict, and suppose they have a 10% error . It is then stated that profits should have a similar error so should be roughly 9 to 11. However, that is totally incorrect.

Revenues, with a 10% error, could be anything from 90 to 110. Costs are locked in at 90. Hence, profits are from 0 to 20.

Notice what happened. Revenues have a 10% error. But profits have a 100% error. The error percentage is huge. Unfortunately, this difficulty is frequent and arises at least to some degree in virtually all financial projections The potential error in profit might explode. A highly trained expert might not make this error, but this general type of error is common and arises in many analyses. Hence, other means would be helpful to deal better with it.

As a final example, suppose there is an introductory statistics class. The professor may inform the students that there is a pond near where she lives and sometimes she watches the ducks land on the water. During one hour watching the pond she observed: 10 Redheads, 6 Black Scooters and 4 Blue Winged Teals. She may ask the students what is the chance the next duck to land is a Redhead? In most cases the students will quickly respond 50%. But the professor will point out that such is wrong, because it assumes the count is accurate, that she knows one duck from the next, and that other ducks were not obscured by the foliage and trees. The point is that in most decisions there is always something missed.

These are all examples of some of the concerns when one is making a decision.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Systems and methods according to present principles meet the needs of the above in several ways.

In a first way, surprise and missed issues are always a concern and easily missed since one might not know what they are. How might one gain some insight into them, given they are unknown. But that is one of the insights, namely, the unknown, namely, employ an additional variable, alternative X, to represent the unknown. In a typical decision, there will be one or more alternatives that are known, say, A, B, C, etc. To that, we add to the equations the unknown variable, alternative X, and, using Bayesian analysis, estimate X, the chance of missed issues and surprise. In practice this surprise metric, X, reflects reality. For instance, the greater the number of inconsistencies, contradictions and gaps in the data, the greater the level of the surprise metric. This makes sense, since the greater the confusion in the data, the greater the chance something was missed. That is reflected in alternative X.

There is the common phrase, “ You do not know, what you do not know.” What alternative X and other methods presented here provide, is a means to begin to know what we do not know.

### Overview of Certain Implementations of the Invention

Certain implementations of the invention are designed to help make better decisions and particularly more outstanding or breakthrough decisions. The decision process will also be adaptive in the sense of being updated over time as new information occurs. It achieves this by being divided into two main, but interactive, components, a Repository of Apps and also a Breakthrough engine, as described in greater detail below;

### Repository of Apps

The first component includes a Repository of decision apps which is a collection of apps or sub-programs, each for a different type of decision. The apps may provide suggestions for making that type of decision successfully and, in essence, provide distilled experience, wisdom and knowledge for making that type of decision. For instance, if one is selecting an information system, one generally wants information about such decisions that were made in the past. Possible risks, surprises, opportunities and other issues that a decision maker should consider when making that type of decision, would be included. One special section of the app will be devoted to ideas and suggestions that might provide breakthrough or especially excellent success with that type of decision. This information may be user contributed in a crowd/open source manner and in the spirit of social media. In short, the app is designed to summarize wisdom and experience in making that type of decision. A major concern in decision making is missing issues. The app, because it contains critical information pertinent to making that type of decision, should help with that concern.

Further the Repository will be open/crowd sourced meaning that any appropriate person can add a new app or update an existing app with new or pertinent information, suggestions or ideas. Thus the number of apps in the Repository will increase over time, so that an increasing number of decisions will be covered, and also their quality should increase over time.as the new knowledge and information is added.

### Breakthrough Engine

The other major component is as noted above a Breakthrough engine, and it will assist in making a given decision. Thus, suppose a decision arises. The decision maker will access the Repository for that type of decision and the corresponding app will suggest factors to consider that should help make that decision a success, and these factors might include risks, possible surprises, opportunities to evaluate, possible breakthrough concepts and so on. But new information might be relevant. Hence, the decision maker will adapt, change and update that information and thereby have revised considerations and issues to be evaluated relative to making the decision being faced.

The Breakthrough engine will then assist in making the decision. However, it will seek an outstanding and, hopefully, breakthrough decision. The Breakthrough engine is designed to prod and encourage better decisions than would have been made without its use. It does this by pointing out possible risks as well as opportunities, and by providing metrics for decision success that indicate how much the decision has to be improved until achieving the level of an excellent or outstanding decision. It achieves this by conducting statistical analyses of the information and data. Furthermore and importantly, the app, as mentioned, may already have suggestions and ideas for making major advancements and breakthroughs of this type of decision, and those ideas may be utilized, as needed. This process would be conducted in an iterative manner where at each iteration the decision would get better and better, until, hopefully achieving a breakthrough level decision.

Once the decision is made, the user would consider what was learned in that process and what happened. At that point the user would add those new insights and knowledge to the app. Thus the app would improve over time as the information in it gets better and more helpful. In this manner, systems and methods according to current principles have created an adaptive and dynamic system not just for making excellent, hopefully, breakthrough decisions but for making, and depending upon the circumstances, ever better decisions over time.

### Breakthroughs

Systems and methods according to present principles provide several means to promote excellent, perhaps breakthrough decisions.

1. A success metric will be provided for the quality or effectiveness of the decision. A high goal will also be provided for that metric, a goal so high that it prods the user to do better than they might have done, for example, 90%. Necessity is the mother of invention, and, similarly, the high goal is the mother of better ideas and breakthroughs.

2. Certain implementations of the invention will statistically identify various risks and biases. Attacking those problems and difficulties leads to better decisions and sometimes breakthroughs.

3. The decision process typically iterates, with the decision getting better each iteration with new ideas. More precisely, a high goal for the success metric would be given, say 90%. Most initial decision attempts rate under that, say 65%. An iteration of the process might increase the metric to 75%. Another iteration to 82%, etc. Usually two or three iterations are needed. The ideas build, getting better and better as one increasingly understands the decision, and after a couple of iterations, often the big picture becomes clearer and breakthrough insights are obtained. It is the iterations, and the learning that fosters, that makes this possible.

4. The app will contain a list of suggestions and ideas useful for obtaining breakthroughs or outstanding results when making the particular decision type being considered. Users and participants may contribute these suggestions over time. Then when a decision is being made, the decision maker would access that list of ideas, and hopefully find an idea that is exciting. In addition, the decision maker might contact the person or people who contributed an idea for discussions.

5. Systems and methods presented here make it highly convenient to test out ideas, and determine if they help improve the decision. The extent to which the success metric increases reflects how good the idea is. Rapid testing of ideas provides another means for improving the decision and improving breakthroughs.

Note that the list of breakthrough suggestions would be different from the success factors. The success factors for a given type of decision would be the more standard considerations needed to make almost any decision of that type successful, for example, cost, marketing, production, etc. The breakthrough list would be the more novel ideas, say, some new technology or social media concept.

Systems and methods according to present principles of thus incorporate several means to promote better decisions and breakthroughs.

Overall, then, the repository contains apps, different apps for different types of decisions. The apps would contain information and suggestions to consider when making that type of decision, including suggestions for breakthroughs. Also, participants would add new apps to the repository and update the apps with new knowledge and insights.

Then, when facing a given decision, the user would gather information from the corresponding app about how to make that decision successfully. The Breakthrough engine would help the user make that decision and, moreover, prod and assist the user to, hopefully, make a better decision than might have been made, possibly an outstanding or breakthrough decision. Lastly, after the decision is made, the user may add to the app any new insights and perceptions gained, thereby improving the app. What results is an adaptive system for decision making that improves over time and should help users to make better decisions than would have been made, including a greater number of breakthrough decisions.

### Advantages of Certain Implementations of the Invention

As this discussion indicates, there are many complexities to decision making. What certain implementations of the invention seek to do differently from other decision approaches includes this—to seek to make a better decision than would have been made, one that, perhaps, is outstanding and even on the breakthrough level. And the superiority of the decision would be demonstrated by an appropriate metric, specifically, the success metric, which estimates the decision's probability of success, and might also be considered a quality or effectiveness metric.

To illustrate, suppose one is an executive and a subordinate recommends that a decision be made. Due to certain implementations of the invention, one may be able to see information in a particularly helpful way, making that decision better than it might have been made without, such as:

1. How well the recommended decision does on a test of its quality or likely effectiveness. That will be provided because there will generally be a list of success factors, that is, considerations and issues, that would determine the success or failure of the decision. How the decision rates on those factors would be obtained, and that would provide an estimated probability of success of the decision, and that information is presented in the success metric. One then can immediately see if the decision has performed sufficiently high on that metric. For instance, the recommended decision might have achieved a 65% on the metric, while the executive may want at least 80%. Hence the recommended decision is too low on the quality metric and needs improvement. Certain implementations of the invention then provides one or more means to accomplish that including the following:
How well the decision attacks risks or biases. Certain implementations of the invention will statistically analyze the information to determine possible risks and biases and that will be displayed. Risks are identified as factors that are weak or might harm the decision. Biases are outliers or other unusual information since biases are usually inconsistent with the other information. Certain implementations of the invention will present that information so those problems can be attacked and the decision improved. But certain implementations of the invention may also hope to promote a breakthrough decision. Hence it may examine:

If the recommended decision has any especially brilliant or breakthrough ideas in it. That is because systems and methods according to present principles may promote promotes breakthrough ideas in several ways, and that will generally be instantly evident.

These capabilities of the disclosed systems and methods, among others, should make decision making easier and promote better decisions and more breakthrough decisions. That may be accomplished employing a variety of methods including social media concepts as well as crowd sourcing and open sourcing.

In another implementation according to present principles, a typical iteration has the following steps: an initial procedure, termed a “smart start” suggests various factors, issues and aspects that should be considered in making the decision. These serve to guide the decision process, at least until better or additional relevant factors are determined. Next an initial trial decision is examined by the systems and methods according to present principles in order to determine its metric values. These metric values might be the probability of success or the estimated valuation, say, financial value, or other pertinent metric. If those metric values are not sufficiently high, for instance, do not achieve the predetermined goals, the systems and methods may be employed to identify issues where the decision might be improved. The decision is then improved, e.g., by the user or the system itself, in the creation of an improved decision. This improved decision becomes the new trial decision. A new iteration repeats the process using this new trial decision. That is, it calculates the metrics of the new trial decision to determine if they are sufficiently high. Etc. The iterations continue until a decision is achieved that is deemed sufficiently excellent, presumably a breakthrough.

Underpinning this is the concept that ideas build upon each other and get better and better. The metrics are employed to ensure the ideas are, in fact, better. Systems and methods according to present principles may also assist in suggesting means to improve the decision. The goal, after a very few iterations, is to create an idea so excellent that it would be considered a breakthrough. Although that high goal is not always achieved, at least the decision should be a distinct improvement over what would have been done without the systems and methods.

As noted, goals are usually declared for the different metrics. For instance, the user might declare that the metric for the quality of the decision should be at least 90%. The user might also declare that the metric for the probability of surprise or missed issues should be less than 10%. If at any iteration the trial decision's metrics do not achieve these goals, then that might be considered an indication to keep iterating and improving the decision.

The systems and methods may structure the decision analysis in the following manner. A single decision option or alternative might be examined to determine if that decision should be made or not. Or there might be a number of alternative decision options to examine, and the decision process is to select the best or the top ones. In some applications the worst or lowest performing alternative is sought and, in that case, the alternatives with the lowest performing metrics are determined. That might occur, for example, if one is seeking to divest the worse performing unit, or to terminate the poorly performing activities.

In order to make the selection, a number of factors or criteria may be developed. At least initially the smart start might be used in order to suggest an initial set of these factors. These would be the factors that would determine if that decision would be successful or not. In a business decision, for example, the factors might include potential revenue, customer acceptance, distribution efficiency, costs, competitor reaction, supplier availability, etc. In an intelligence decision about whether the enemy will attack, the factors might include position of troops, preparatory steps, level of training, levels of readiness, provocations, weapons capability etc. The most likely course of action, or most dangerous course of action, could be determined. In a decision about what new product to develop, the factors might include cost of development, time of development, level of challenges to be overcome in development, customer acceptance, competitive position, etc. In a decision about who will win an election, considerations might include polling numbers, name recognition, effectiveness of campaign, likely funding, demographics, grass roots campaign, social media, etc. In a decision about competitive bidding and what proposal to submit, the factors might carefully examine what the customer is seeking, costs, what the competitors are likely to bid, where the competitors are strong and where they are weak, etc.

Each of the various factors may then receive a weighting for its importance that indicates to what degree it will influence the success or lack thereof, of the decision alternatives. That is because some factors are more important than others. The smart start might also provide information on the weighting or relative importance of the different factors.

At this point, the potential decision or decision alternatives may then be rated on each of the various factors. If the given factor strongly supports the success of the decision, that decision option may receive a high or very high rating on that factor. For instance, low costs might be strongly supportive of some particular investment alternative. For factors that might indicate the decision alternative would fail or do poorly, such would receive a poor or negative rating. In this manner each decision alternative would receive ratings on the different factors that should predict its success. Some of those factors might predict success and others failure. Still others might be neutral or have little impact.

The systems and methods may then translate these rating into probabilities and on the basis of that, determine the probability a given decision will be successful and is the correct choice. For example, alternatives for which virtually all of the success factors predict success might receive a high probability of success. Metrics then display that information.

The level of risks is also examined. This is accomplished by considering the level of weakness or potential harm to the decision's success. The greater that level of weaknesses or threats, the greater the danger and the greater the chance of risks, surprise or black swans. This information is also employed to calculate metrics for that information.

On the basis of these metrics, the user can evaluate if the trial decision is likely to be sufficiently successful. Goals for the performance of a decision on the various metrics are usually given.

The smart start seeks to suggest factors that are likely to predict the success or failure of the decision, as these would then be considered in the decision process. The smart start might be considered a “big data” statistical approach, or a kin to that. But that would be inaccurate because for these types of decisions there are very few examples (very small n), too many variables, and considerable uncertainty. Often one must predict the actions of other humans, say competitors or enemies, in complex and new situations, something that statistically is very difficult. Hence, human judgment and experience must also be a major input.

Another aspect as noted above includes financials. Traditional financial projections forecast various financial values and from that information, estimate the financial value. The Financial approach proceeds differently. It compares the given situation to other reference situations. Depending upon its proximity to the reference situations, that suggests that the situation being examined would have a similar valuation. Interpolation may be employed for one or more variables, including valuation. That might be adjusted for changes in circumstance, but the basic calculation is founded on the degree of similarity to various reference situations.

Another aspect of certain implementations of systems and methods according to present principles include that the same highlight possible weaknesses or flaws in the decision such as risks, bias, missed issues or potential for surprise. The same may also highlight possible opportunities that would improve the decision. This information permits the user to improve the decision thereby creating a new and better decision. This revised or new decision option then becomes the new trial decision for the next iteration.

In practice, and by following the invention, nearly all initial decisions can be improved. Usually, excellent decisions can be attained in 2-3 iterations.

Several aspects make the decision process according to present principles distinctive. One as noted is termed a “smart start” capability which provides suggestions about factors and issues to be considered in the process of making the particular type of decision. The information in the smart start may be updated both automatically and based upon human input. Having such information at the beginning tends to facilitate the decision process. The iterations may then be undertaken, the decision getting better and better each time, until achieving the desired level of excellence, presumably the breakthrough.

Another distinctive aspect as noted is termed herein a “financial” valuation which enables the very rapid prediction of the financial value or other numerical benefit of a decision. This permits valuation of situations where traditional analysis would be excessively time consuming to have their value forecast. In many situations, that is critical information as one seeks to obtain the exceptionally good decision. The financial process provides another means to evaluate the quality of the decision and if the decision has achieved the level of an excellent or outstanding decision, or if further iterations are needed.

A further distinctive aspect is that systems and methods may use an iterative process that seeks to create better and better ideas and decisions, where the ideas build upon each other until achieving, hopefully, the breakthrough, the exceptionally powerful and novel decision, solution or conclusion. Or, if no breakthrough is achieved, the ideas developed should still be a distinct improvement. Since the systems and methods according to present principles uncover and point out issues and considerations that should be improved and were likely missed, the result is typically a decision that is better than those involved thought they could make. Overall, the result sought is a decision, idea or perception better than those involved even imagined prior to their application of the systems and methods.

In one aspect, the invention is directed towards a modular system for decision-making and analysis with the goal of making better decisions than might have been made, and obtaining more outstanding or breakthrough decisions, including: a repository or collection of apps or subprograms, each app for a different type of decision, and configured to provide background and information that would help make a decision of that type better; a breakthrough engine for making the actual decision, designed to utilize data from the repository; a user interface to allow a user to update information in an app, such that future uses of the app result in decisions of higher quality, thereby creating an adaptive decision-making process.

Implementations of the invention may include one or more of the following. The app may include information relevant to making the type of decision, the information including: one or more success factors, where the success factors are criteria to be considered in making a successful decision; and one or more breakthrough ideas or insights, the breakthrough ideas or insights, suggestions of how to make the decision a breakthrough decision, where a breakthrough decision is one having a quality metric exceeding a predetermined threshold. The system may further include a user interface or API for crowd sourcing, such that users are enabled to add or edit data in the repository or collection of apps or subprograms, whereby the same is kept up-to-date and with important information relevant to making a decision successful, and further including: a user interface for reviewing and refereeing data from the user interface for crowd sourcing; and a security module for controlling access for users to the user interface for crowd sourcing. The user interface may be configured to display information about the identity of users to the user interface for crowd sourcing, and may provide a means to communicate with such users. The system may further include a user interface whereby users to the user interface for crowd sourcing are enabled to rate and comment on apps, whereby the value of different comments and contributions to the apps may be conveniently displayed, and contributions be rewarded or recognized.

In another aspect, the invention is directed towards an iterative method of decision-making and analysis, including: receiving a first decision; performing a calculation of a weakness or strength of the first decision, or both; performing a calculation of a quality metric of the first decision; if the quality metric of the first decision is below a predetermined threshold, then determining a revised decision based at least in part on the calculated weakness or strength or both; performing the calculation of the quality metric on the revised decision; if the quality metric of the revised decision is below a predetermined threshold, then performing a calculation of a weakness or strength on the revised decision, and determining a new revised decision based at least in part on the calculated weakness or strength or both of the revised decision, and if the quality metric of the revised decision is at or above the predetermined threshold, then determining the revised decision to be a final decision.

Implementations of the invention may include one or more of the following. The quality metric may be a likelihood of success for excellence. The performing a calculation of a weakness or strength of the first decision or the revised decision may further include: entering one or more alternative options into a database; for each of the alternative options, entering at least one criterion or factor for evaluating the alternative option; specifying a relative importance of each of the criteria or factors; specifying, for each alternative option, a strength rating, where the specifying a strength rating indicates how well the criteria or factor either supports the option or opposes the option; and calculating a result for each alternative option based on the relative importance and strength rating. The method may further include providing one or more metrics for the quality, excellence, and likelihood of success of any of the alternative decision options, the metrics based upon underlying factors that will determine the alternative option's success. The method may further include establishing one or more goals for one or more respective metrics. If no alternative option has a goal that is met or exceeded by its respective metric, then the method may further include performing another iteration of the process. The metrics may include metrics for the weaknesses of the decision, including risks, issues missed, and surprises. The method may further include analyzing the alternative options to determine overconfidence, confirmation, or other positive bias, by statistically identifying ratings that are outliers or excessively high in comparison with other ratings, and revising identified ratings or alternative options in response thereto. The method may further include analyzing the alternative options to determine negative bias or efforts to discount or downplay alternatives that are considered undesirable, by statistically identifying ratings that are unusually low or weak in comparison with other ratings, and revising identified ratings or alternative options in response thereto. The method may further include analyzing the alternative options to identify surprises or threats against any particular alternative, by analyzing where there are ratings that are stronger than comparable ratings for a given alternative, and further including calculating means to counter such identified surprises or threats. The method may further include analyzing the alternative options to identify risks against any particular alternative, by analyzing where there are ratings that are weaker or lower relative to other ratings for that alternative, and further including calculating means to counter or overcome such identified risks. The method may further include: formulating one or more new alternative decisions; testing an effectiveness of the one or more new alternative decisions; testing the one or more new alternative decisions to determine to what degree they might improve the overall decision. The method may further include receiving input from one or more users acting as critical decision-makers, whereby the final decision is improved by receiving input from multiple parties. The method may further include, in response to input from a user about the type of decision, generating a list of one or more factors or issues suggested to be appropriate for consideration in that type of decision, and receiving input from a user corresponding to at least one of the generated list. The method may further include generating default ratings for the generated list of one or more factors or issues, the default ratings generated by a method selected from the group consisting of: user input, a frequency with which the factor or issue was selected in the past, an importance given to the factor or issue in the past, information on how relevant the factor or issue was in determining a correct decision in the past, or combinations of the above. The method may further include receiving and storing comments from users about how to make a decision and what aspects to examine more carefully. The method may further include receiving a financial, benefit, or other metric valuation, further including: receiving information about one or more reference alternative options, each of the one or more reference alternative options associated with a value; and determining how close an alternative option is to the one or more reference alternative options; and valuing the alternative option based on how close the alternative option is to the one or more reference alternative options, and the respective values of the reference alternative options. The method may include that two reference alternative options are provided, a high valuation reference alternative option and a low valuation reference alternative option, and the method may further include evaluating each of the two reference alternative options for underlying factors that predict success, where the high valuation reference option has a high probability of success, and the low valuation reference has a a low probability of success. The method may further include analyzing a current situation by analogizing the current situation to its closeness to the high valuation reference alternative option and the low valuation reference alternative option. The method may further include determining an impact of the factor or issue on a valuation of a current situation, by removing a factor or issue from a valuation analysis and determining the change in the valuation due to the absence of the factor or issue, whereby the importance of the factor or issue may be determined, such that factors or issues that have a major impact on improving a valuation would be highly important to that valuation, and factors that are weak or harmful might be identified as risks.

In a related aspect, the invention is directed towards a non-transitory computer readable medium, including instructions for causing a computing environment to perform the above method.

In yet another aspect, the invention is directed towards an iterative method of decision-making and analysis, including: receiving a type of decision; determining one or more factors bearing on the type of decision; determining a first decision; rating the determined one or more factors with respect to the determined first decision; determining a quality metric of the first decision; if the quality metric of the first decision is below a predetermined threshold, then performing an analysis of the first decision and the determined one or more factors to determine a revised decision; performing the calculation of the quality metric on the revised decision; and if the quality metric of the revised decision is below a predetermined threshold, then performing an analysis of the revised decision and the determined one or more factors to determine a new revised decision, and if the quality metric of the revised decision is at or above the predetermined threshold, then determining the revised decision to be a final decision.

In a related aspect, the invention is directed towards a non-transitory computer readable medium, including instructions for causing a computing environment to perform the above method.

It should be noted that, in contrast to prior work, current systems and methods according to present principles do not necessarily seek the best or most likely alternative or choice. Or if there is but one alternative, if that alternative should be selected and made or not (although in some implementations such actions or activities could be performed within the context of present principles). Rather, systems and methods according to present principles seek to obtain a better decision than any that have been entered or thus far considered. They seek to obtain better and better decisions and alternatives that might not have been considered or even imagined prior to employing the same. The goal is to make increasingly good decisions with the goal of achieving, hopefully, a breakthrough decision for the situation being examined.

The metric calculations of certain systems and methods according to present examples are also distinctive. For example, certain prior work calculated probabilities in a relative fashion, e.g., what was the probability a given alternative was best or would occur, and this was in comparison to the other alternatives. For instance, with three alternative possibilities, the probabilities might be 50%, 20%, 30%. Thus the first one has a 50% chance to be the winner among the three possibilities. The assumption of mutually exclusivity was also made, where if one alternative occurs, the others cannot.

In contrast, it is noted that for certain implementations of systems and methods disclosed herein, the probabilities pertain only to that particular alternative. The metric provides the probability that particular alternative will be successful or achieve some goal. Given three possibilities, the probabilities might be 75%, 30%, 45%. Here possibility one has 75% probability of success, possibility two has an 30% chance of success, and the third a 45% chance of success.

Employing this new metric permits the iterative improvement. In the example just given, possibility one has a 75% chance of success, which is highest of the group. But it is still under a 90% goal. Hence, improvement is required. The systems and methods according to present principles can thus provide a signal that improvement is needed.

Moreover, with systems and methods according to present principles there is no requirement that only one alternative occur. Several of them might be selected since the success metric for each is calculated separately for each.

The systems and methods according to present principles help to obtain the improvement, e.g., by highlighting various rating cells, which suggest ways to improve the decision. Certain cells may be highlighted to show potential risks or dangers that should be countered. Other cells might reflect biases or suspect assumptions. Other cells might suggest potential opportunities. By examining the highlighted cells, the user is then able to improve the decision.

The information may be obtained in a number of ways. For example, the systems and methods according to present principles might highlight factors or considerations where a competitor is stronger or where some other alternative is stronger. That suggests that the decision should be improved on those factors. In complex situations, that information is often missed without the assistance of the systems and methods according to present principles, which provide that information automatically.

The systems and methods according to present principles may also seek to discern inconsistencies, contradictions or other gaps in the reasoning or information. Those are indications of possible risks and are often missed in the confusion and uncertainty of real decisions.

Information that is a statistical outlier or statistically unusual is also highlighted by the systems and methods according to present principles, since such information often signals bias or a false assumption. One example of this is the identification of possible negative bias, that is, where one subconsciously discounts or disparages information or approaches that disagree with one's personal opinion or biases.

As another advancement, the systems and methods according to present principles strive for breakthrough decisions, decisions that are notable for their power and effectiveness. This is accomplished by the iterations, where at each iteration the decisions developed would get increasingly excellent, better and better, until, ideally, achieving the breakthrough.

One or more of these advancements are what permit the iterative improvement process. More precisely, the metrics according to systems and methods according to present principles are different from prior work, and they enable less than excellent performance to be signaled. The systems and methods according to present principles then suggest possibilities to obtain improvement. Those advancements permit the iterative cycle. Each cycle, the metrics should improve until achieving the high performance goals, hopefully, the breakthrough. In particular, it is the systematic building of better and better ideas, that underpin the ability of systems and methods according to present principles to obtain breakthrough decisions.

### Discussion of Examples Discussed Above

How might the methods and systems herein assist with the examples presented above. Consider first the example about the ROI calculation error. The app should contain a warning of such an error. That, hopefully, would prevent that error. Or, in the worst case, suppose nothing was included in the app. Then when that error was made, perhaps by a non-expert person, it should be caught. At that point the warning of the potential error would be added to the app, since the app is designed to be adaptive and improve over time.

What about the difficulty with the duck example and the probability analysis. The discussion about alternative X is relevant here, and should provide warning of it. Moreover, such potential errors should be warned about in the app.

What about the example of the huge error increase in profit projection in comparison with the error in revenue projection. That would be handled by employing the comparables approach suggested.

Thus for all the examples discussed , the methods and systems presented here should provide assistance and improve the situation.

Advantages of the invention may include, in certain embodiments, one or more of the following. Systems and methods according to present principles are designed to assist with complex decisions such as those involving strategy, major capital expenditures, M&A, competitive bidding, major projects, new ventures as well as military, government, social and political decisions, and so on. Such systems and methods are rapid and can be performed with little specific financial knowledge. Systems and methods improve forecasting accuracy and provide further means to create decisions that are exceptional if not breakthroughs. Other advantages will be understood from the description that follows, including the figures and claims.

This Summary is provided to introduce a selection of concepts in a simplified form. The concepts are further described in the Detailed Description section. Elements or steps other than those described in this Summary are possible, and no element or step is necessarily required.

This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is a flowchart showing the interaction between modules in a process for improving decisions and seeing breakthroughs.

FIG. 2 is a flowchart showing a process for improving decisions and seeing breakthroughs.

FIG. 3 shows an illustration of a “smart start” procedure indicating lists of suggested factors, issues, and aspects to be considered in a decision, and the effect of “drilling down” to a desired granularity of factors.

FIG. 4 is a flowchart of a method according to present principles.

FIG. 5 is a user interface according to present principles.

FIG. 6 is a user interface according to present principles showing highlighted risks.

FIG. 7 is a user interface according to present principle showing an alternative decision option, and an increased quality metric thereof

FIG. 8 illustrates the use of references in determining valuation.

Like reference numerals refer to like elements throughout. Elements are not to scale unless otherwise noted.

### DETAILED DESCRIPTION

This application incorporates by reference U.S. Pat. No. 7,676,446 B2, awarded Mar. 9, 2010 entitled “Method and System for Making Decisions” and also U.S. Pat. No. 8,442,932 B2 entitled “Method and System for Making Decisions” awarded May 14, 2013.

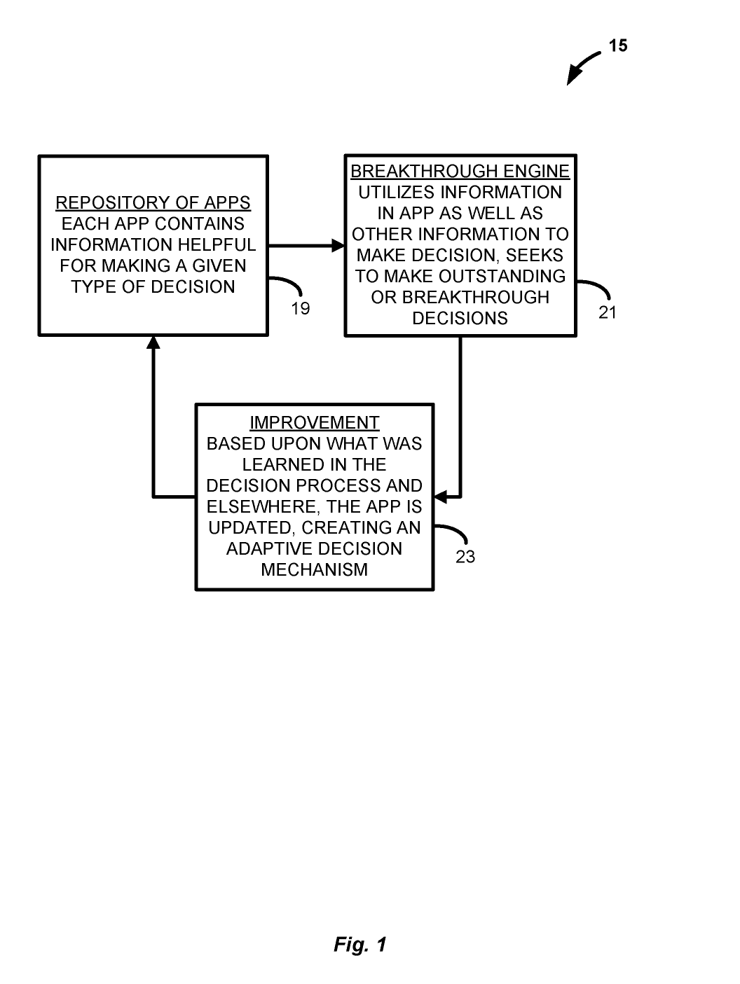

Referring to the modular system 15 of FIG. 1, a first implementation of systems and methods according to present principles is discussed in the context of a repository 19 and a breakthrough engine 21. An improvement module 23 is employed to update apps in the repository of apps 19, creating an adaptive decision mechanism.

### Repository

The Repository 19 is a collection of apps or sub-programs, each app being focused on a specific type of decision. Different apps might be created for different investments, for different supplier selection situations, for new products, for different types of acquisition, for where the enemy might attack, and so on.

The Repository may have a search feature that would enable the user to search for any particular app of interest. A few apps that are likely choices would be displayed in summary form and that would enable the user to select the app most similar to the decision she faced.

The specific apps would be added to the Repository by the participating personnel. That is, any appropriate person could add a new app. For that there would be templates to fill out that would request the information needed to create a new app. In this manner, the apps would be crowd/open sourced.

Initially, there would be few apps, but their number should increase over time until covering most of the important decisions the organization or relevant universe of people might face.

Any new information or revision of an app would be checked and approved by a designed referee or umpire.

Moreover, if any person adds new information or revised information, that person would be listed. That would enable that person to be contacted if further information were needed. If necessary, an intermediary step could be employed to shield the identity of that person, where the intermediary would approve the revealing of the person.

### Apps

Systems and methods according to present principles may be embodied in one or more applications, e.g., downloadable applications, or “Apps”.

Given the type of decision, the purpose of the app is to provide solid wisdom, experience and advice for making that type of decision. In a crowd/open source manner, participants would contribute to it over time, thereby creating a better and better app.

Sections of each app might provide background on making that type of decision, as well as examples. Some users might contribute discussion or blogs. But conceptually, the app should contain information that would help a decision maker make a, hopefully, outstanding decision.

### Breakthrough List

A special section of the app may be devoted to ideas and suggestions for achieving breakthroughs or significant advancements in the success of the decision. These ideas might have been successful in the past or might be new or untried ideas. But the suggestions would be considered potentially beneficial for possibly producing breakthrough results for this type of decision.

### Ratings

Further, the app may be designed to be concise so the executive user, who is often rushed, can obtain critical insights quickly. One means to accomplish this would be a rating and reader review system, where users of the app would rate which suggestions in the app were more helpful. The star rating for a movie or restaurant, or the reader comments on Amazon, are analogies. An individual using the app would then immediately see the accumulated collective wisdom of the users by checking the ratings and reviews.

### Contacting and Recognizing Contributors

Participants will contribute the information in an open/crowd-source manner. If a user sees an interesting contribution, they should be able to contact the contributor of that for further discussion. Additionally, a contributor who is often cited and contacted, and thus contributes information the users feel is valuable, might receive special recognition. The Repository would keep track of contibutors and contactors to facilitate this interaction. Of course, security, confidentiality and privacy issues need to be observed here.

In more detail, the app itself would contain several sections. One would be a short description of the type of decision explored by that app.

### Success Factors

Another major section may be a listing and brief description of various “success” factors, that is, considerations, issues and concerns that would influence the success of the decision. Some of these factors would be necessary to accomplish or deal with in order to make the decision successful. For example, a product must be manufactured, delivered, sold, etc. Other factors might be risks or tend to thwart the success of the decision such as bad weather, competition, technology failure. These risks or dangers must also be considered in estimating the possible success of the decision. The “success” factors would include both types as both are relevant to the success of the decision.

Generally in making a decision, there are one or more alternative choices or options. Examples of these would be given in order to suggest possibilities to the decision maker.

A particularly important section would be the ideas for breakthroughs or achieving outstanding success for the decision. Various possible suggestions would be listed along with brief descriptions.

Other background material, reference and related material might be given. Various discussions or blogs might be included.

Just as above, the material would typically be user sourced from the participants, who would enter the material. A referee might be employed to ensure content integrity, as needed.

As part of each listing there would be a rating system, such as stars along with comments. That means, participants would be able to rate the value of any entry and discuss it. A rating that receives a high star rating from a number of individuals would, presumably, be deemed more likely to be helpful or important. Of course, an entry with low rating might also be important in certain circumstances, but the stars should provide useful information.

Typically, there would be more entries than needed for the given decision being faced. Indeed, too many entries may be desirable as then the decision maker would be able to review them and that would help her not miss anything. However, a decision maker may be enabled to select any entry, edit it, and insert it into the Breakthrough engine. The concept is to provide a list of possibly relevant considerations. The decision maker would select those most appropriate and then those would be automatically entered into the Breakthrough engine.

More Information on Entries

The source of the entries may be given, that is, the individual who contributed it or others knowledgeable about that particular entry. (Although in certain circumstances an intermediary might be needed for privacy or confidentiality.) This would permit the decision maker to contact that person (or other knowledgeable individuals) if should there be any questions or need for discussion. This capability of contacting the person may in some cases be very important. For instance, suppose a risk is identified. Then it might help to contact an expert on that risk about the best way to ameliorate the risk. Such contact would be especially for the breakthrough listings. Often breakthroughs require discussion and this capability permits that.

### Incentive for Contribution:

Contributors of entries could also be recognized. If a person contributes entries that receive high star ratings, that suggests that those entries were deemed important. Another indication of importance is if that entry is select for use frequently. Systems and methods according to present principles may keep track of what entries seem superior in terms of ratings or other criteria, and who contributed those entries. Individuals who contribute entries might be recognized and thanked in some manner. Individuals who contribute more or better entries might also be recognized and thanked. This mechanism creates an incentive for individuals to contribute and make entries.

### Breakthrough Engine

The breakthrough engine 21 is also an application, generally embodied on a non-transitory computer readable medium, which accesses the repository of apps 19, as well as other data in some implementations, and utilizes such information to make decisions and in many cases to seek to make outstanding or breakthrough decisions.

When confronted with a given decision, the decision maker would access the Repository and select the app most relevant, as the app would save time and help the decision maker make a better and perhaps a breakthrough decision. The decision maker would select appropriate success factors from the app, adjust them as needed for the decision being faced, and also add success factors that would be useful for the decision at hand.

Systems and methods according to current principles also permit the importance of individual factors to be included, as some factors would be more relevant to the decision's success than others.

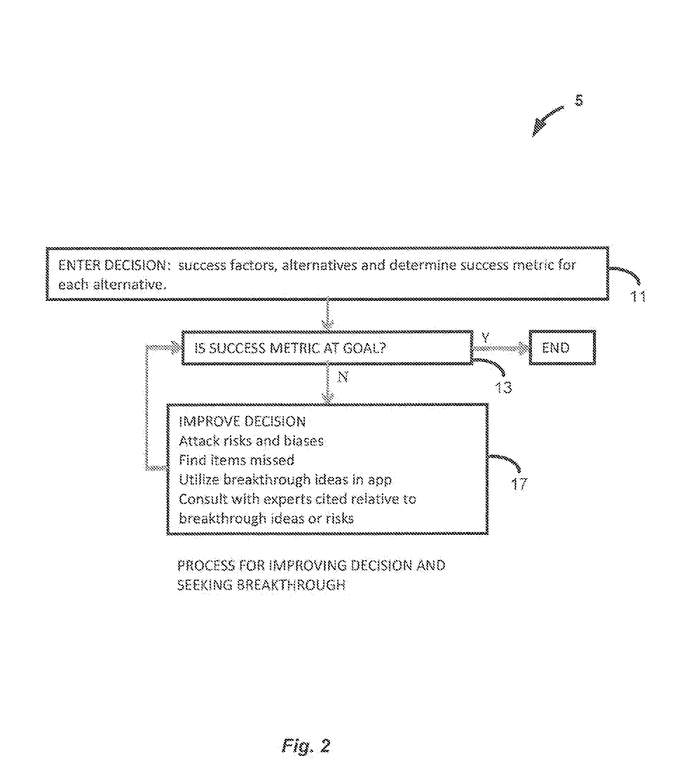

In one implementation, and referring to the flowchart 5 of FIG. 2, the decision maker consider one or more alternatives for the decision, and might access the app for suggestions (step 11).

For each alternative, each factor would then receive a rating that reflected its impact on the probability of success of that decision alternative. Some factors would definitely be helpful while others might be risks or dangers and lower the chance of the decision's success. The breakthrough engine may then transform those ratings into conditional probabilities and, using Bayesian analysis, calculate the estimated probability each alternative would be successful. Thus any alternative would have a corresponding success metric that estimates that alternatives's probability of success. (Depending upon the context, the success metric might also be termed the quality metric or effectiveness metric.)

### Goals for Success Metric

Relevant to that success metric, the decision maker also provides a goal. A typical goal might be say, 90% on the success metric. It turns out that 90% is quite high and often a challenge to achieve. A 90% level would typically be in the breakthrough decision realm. The success metric may then be compared to the goal (step 13). Thus, in the typical situation, the initial decision produces a success metric value below goal.

This is a very important situation, as steps may now be taken to improve the decision (step 17). In this manner, systems and methods according to present principles are “forcing” or at least strongly encouraging that a better decision be made.

How then do such systems help make a better decision, perhaps one achieving breakthrough level?

Useful information the systems and methods provide include the surprise/missed issues metric and also the black swan metric. The surprise/missed issues metric is estimated by positing another state condition to the situation, termed here state or situation X. The Bayesian calculations then provide its probability. The black swan represents a refinement of that calculation that, in effect, estimates the unknowns of the class of unknowns, that is, the unknown unknowns. That comprises the black swans.

High levels on the surprise/issues missed metric or black swan metric is a signal to examine the situation further as it suggests important information has been missed.

To help identify that and produce improvement, systems and methods according to present principles may provide information on possible risks and biases. Risks are weak factors that might cause problems. Biases are factors that are excessive or outliers as that often reflects bias.

Attacking and ameliorating risks and biases typically leads to a new decision with an improved success metric. But that improved decision still might not be sufficiently high to achieve the goal. New risks and biases might be examined and the decision improved further.

Another and quite useful means to promote improvement and possibly breakthroughs, is to examine the list of breakthrough suggestions in the app. That often contains helpful suggestions. Further, the decision maker can contact the person who made the breakthrough suggestion (or others knowledgeable) and speak with them. That interaction often produces an excellent breakthrough idea and improved decision.

The success metric of this new decision is determined, and if the decision has achieved the level of 90% and an outstanding decision. If necessary, this improvement process is repeated and iterated again until achieving a satisfactory level of decision.

In this manner, systems and methods according to present principles cause a better decision than that which would have been made, and indeed one that might be at breakthrough level.

### Financial Valuation

The methods and systems according to present principles permit a new method for providing financial valuation. It is a comparables approach that allows the non-expert in finance to conduct a financial valuation.

Suppose one wants to determine the financial value of a project or activity. Start with two other similar projects for which the financial value has already been determined. Preferably one should have a high valuation and the other low. These two projects serve as references. And using present principles, their success metrics may be determined.

For the project under consideration, determine its success metric. Using interpolation, determine the project's financial value by interpolating. For instance, if the success metric of the project being valued has a success metric half-way between the success metrics of the two references, then the estimated value of the project is also half-way between.

The systems and methods according to present principles also permit a cross-check of the methodology. Consider a third reference for which the financial value is known. Determine its success metric as described and its financial value using interpolation. If the result obtained is close to its actual value, than that provides a cross check. If the value provided in this manner is not close, it means that some factors have been missed and that should be investigated. Conceptually, however, this provides a means to cross-check or double check the mechanism for conducting financial valuations, and which can be performed without significant financial valuation experience.

### Adaptive Improvement

In the process of making the decision, improving it and proceeding to implement it, new insights are usually obtained. Those insights are then added to the app, thereby keeping the app up to date with the latest and most complete information. This thus reflects an adaptive improvement aspect, as over time the information in the app helpful, for making the decision, should get better and better.

### Discussion Of Exemplary Method of Breakthrough Engine

Suppose a user must make a decision. One first step is to consider the “success” factors, that is, the considerations, issues, facts and concerns to evaluate relative to making the decision. To obtain those, the user may access the Repository, search for the decision app similar to the situation she is presently confronting, and examine the various success factors listed there. She would select those relevant to her situation. She may also add other concerns that might be relevant to the situation to update the success factor information and make it as applicable as possible to the current situation. She then has obtained a list of success factors to start, although she might update or change those as needed. Some of these factors to consider might assist and contribute to the success of the decision, while others might be risks that might harm, and hence the decision maker should take actions to ameliorate or prevent them. The different factors would be weighted as to their importance in achieving or thwarting the goal of the decision.

Next, she considers one or more alternative decisions, that is, different options, choices or possibilities, for the specific decision. Often there are several possible choices, although there is always at least one possibility.

At this point each alternative is rated on each of the factors. This specifies how much each factor contributes to achieving the goal of the decision. The ratings are then transformed into conditional probabilities that express the extent to which that factor contributes to the goal or success of the decision. Employing a Bayesian analysis with those probabilities permits the calculation of the probability the specific alternative will achieve the goal of the decision. The result is the estimated success of that alternative, as it reflects how effective that decision choice would be in achieving the goal. This estimated success provides the success metric, also termed quality or effectiveness metric, as it estimates the quality or effectiveness of the decision.

### Pursuing Breakthroughs

Usually one alternative will rate highest in the quality or effectiveness metric, thus suggesting that that alternative would be best in achieving the goal. Certain implementations of the invention seek to do better than that, meaning, to encourage and help the user to achieve an even better decision, possibly one that is outstanding or a breakthrough.

To pursue the breakthrough, first the user would establish a very high goal for the effectiveness or quality metric, say, 90%. The goals established would be higher than any effectiveness metric of any alternative examined to this point.

At this point the systems and methods according to present principles may help the user improve the decision, thereby elevating the metric higher and closer to the goal of 90%. To achieve that the systems and methods first help identify various risk, biases or anomalies. This is done by examining the various ratings in order to identify those that are unusual. Ratings that indicate a factor might thwart or act to make achieving the decision more difficult would be highlighted as risks. Ratings that might be outliers or anomalous might indicate biases as they are possibly inconsistent with the other information. In this manner the systems and methods may statistically identify possible problems and risks for the decision. Similarly, if the systems and methods identify factors are strongly positive or that strongly support the goal of the decision, they might be highlighted as possible opportunities to expand or extend.

At this point the user may employ that information to improve the decision, that is, to attack the various risks and biases and to seize the opportunities identified. This then improves the decision and the user has obtained a better decision than she had.

An analogy here is variance analysis in budgeting or project management. Aspects that are over budget or behind schedule are examined to reduce costs or cut time. Aspects that are below budget or ahead of schedule are examined to determine why that occurred so those results can be expanded and furthered.

Further, as noted, in the app for this type of decision a list of breakthrough ideas that might contribute to breakthroughs was developed. The user would examine that list for possible ideas to enhance the success of the decision. Further and subject to appropriate security and privacy concerns, the user may be enabled to contact the contributor of an idea for further discussion. Such discussions might further the brilliance of the contributed idea.

In this manner, the decision is improved. The success metric is examined. If still below goal, the process is repeated and the decision is improved again. Usually after two or three iterations, significant advancement has occurred and a decision is attained substantially better that initially conceived, often a breakthrough.

A variation of the above described system and method is now set forth. In this variation, prior knowledge, set forth in FIGS. 1 and 2 as apps, are now described in the context of a “smart start” procedure.

### Smart Start

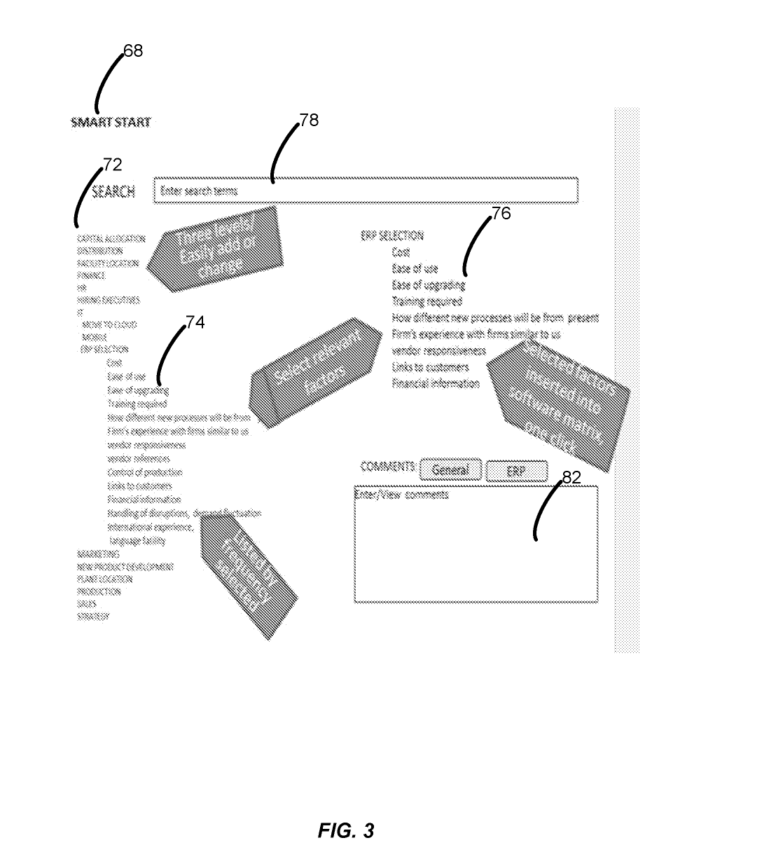

Referring to FIG. 3, to deal with complexities and promote excellent decisions, systems and methods according to present principles operate in one specific implementation as follows. First the type or classification of the decision may be considered. Perhaps it is to locate a new plant, launch a new product, make an acquisition, attack the enemy, predict the attack of a terrorist, or other difficult decision or evaluation. Give that type of decision, a “smart start” procedure could be initiated under that type of decision. That procedure, which is illustrated by a diagram 68 in FIG. 3 and which in many ways is similar to an investigation, may yield a list of pertinent factors, issues and considerations that have been deemed or proven highly useful in making that type of decision successful. For a new product development, for instance, such factors might include: cost of the new product relative to competition, on what aspects the new product is superior to the competition, the likelihood the customer will perceive the advantages of the new product over the competition, the response of the customer in trials or tests of the new product, the superiority of the technology imbedded in the new product, the ingenuity and likely effectiveness of the proposed marketing and sales, etc. The smart start might also include comments on how to make the new product successful.

In more detail, there may be a listing of high level types of decisions (see listing 72), for example, plant location, IT selection, new product development, capital allocation, etc. The users, by clicking or selecting one of these high level decisions, that is, by “drilling down”, would open a list of more specific, sub-category decisions (see listing 74) under the category of the higher level decision. For new product development, the sub-categories might be: new product based upon advanced technology, product extension, new packaging, etc. Clicking or selecting one of these would open a third level which would provide specific factors to be considered for this specific type of decision. (Additional or fewer levels of drill down could be employed, as appropriate.) The goal of the drill down is to very quickly, hopefully in a couple clicks, allow the user to see factors that would assist in making the decision under consideration.

Depending upon the specific decision, not all of the factors listed would likely be useful. Thus, the user may select a subset of the factors for use in the specific decision being faced see listing 76). These may serve to initially populate the other aspects and be employed in making the specific decision.

Having a list of the factors right in front of the user helps her not miss issues. Furthermore, the importance of the factors may also be indicated. Those factors rated of higher importance would suggest that the user pay more attention to these factors.

The importance of the different factors would be provided in two ways. One would be human input. The other would be actual usage over time. Factors that were employed more often would be deemed to be more important and be elevated in importance rating. This would be done automatically by systems and methods according to present principles by noting which factors were selected for usage more often. The value of the factor in producing the correct outcome would also be relevant for the importance rating.

In addition, in a COMMENTS section 82 users would be enabled to add comments and advice about how to tackle this type of decision problem.

Various factors relevant for different decisions may be given and the user may select those pertinent to the decision being faced. The importance of the factors would also be indicated both by human input and also automatically based upon the usage and effectiveness of the factor. Although factors of low importance might be relevant, the user is generally advised to well consider the factors deemed of higher importance. A search field (see field 78) may be employed to allow the user to search based on technology or business area other potential factors, issues, or aspects to consider.

### First Decision

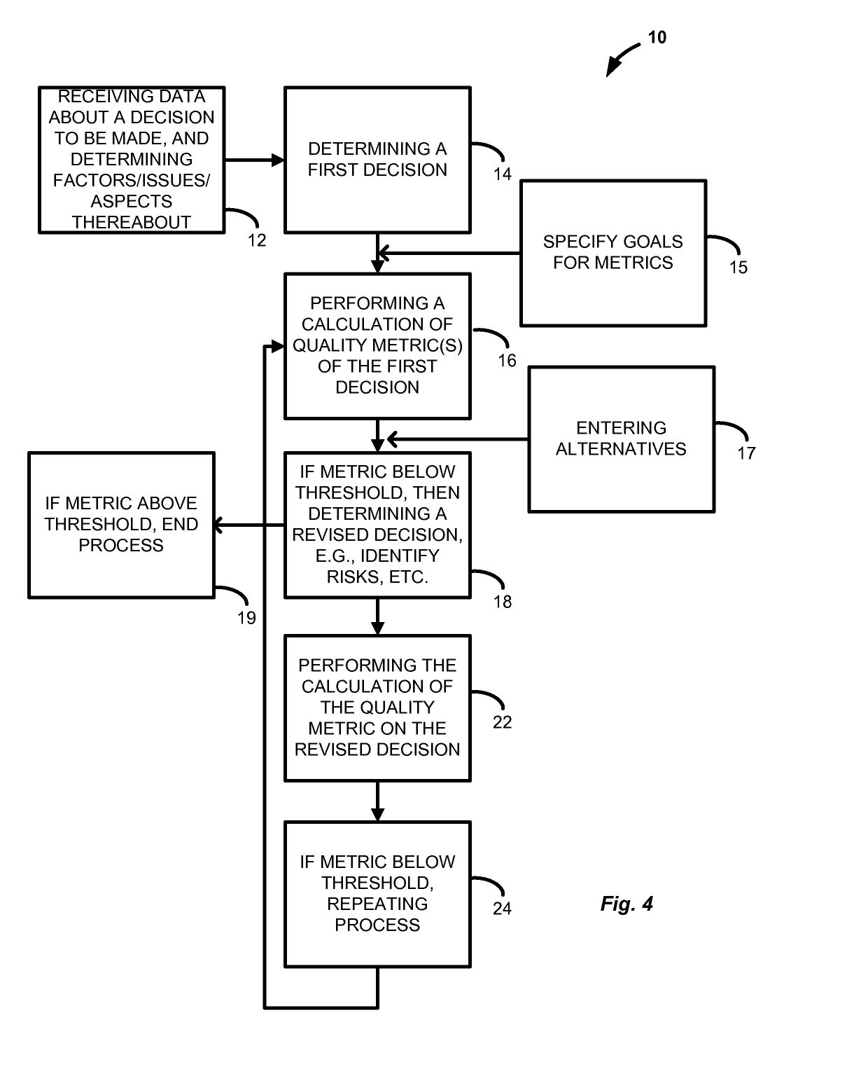

Referring to FIG. 4, the above procedure is indicated by step 12 of the flowchart 10. Next, a first decision is proposed or otherwise determined (step 14 of FIG. 4). This might be determined by employing the systems and methods according to present principles or by other means, but this first decision becomes the initial trial decision. Often this initial trial decision has been made by humans perhaps with computer assistance and would ordinarily be considered a good if not excellent decision. The purpose of present principles, however, is to improve the decision and make it even better, thereby producing a decision beyond what would have been made, hopefully a breakthrough or a particularly novel and excellent decision for the situation being examined.

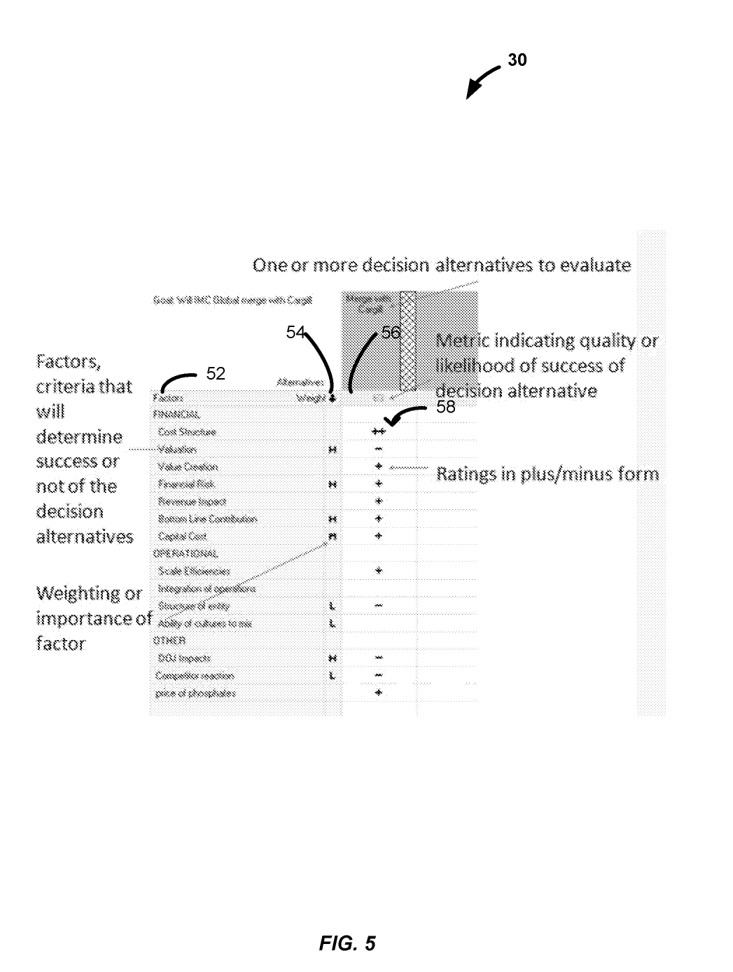

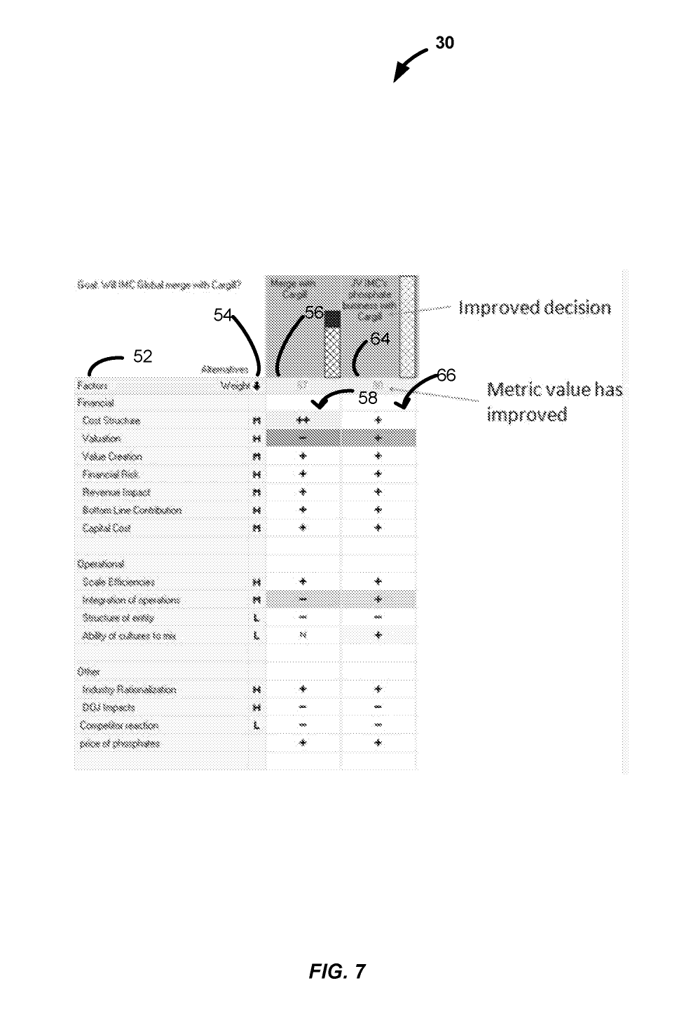

In more detail, as a first step, in one implementation of present principles, the user performs the initial data entry. That begins by entering the major factors, criteria or considerations that predict success or failure, of the decision. These constitute the major facts, factors, events and other considerations of the situation that are expected to be important in predicting the success of the decision. Included should be factors or criteria that will determine the decision's success as well as factors that might prevent or harm the chance of success. For example, consider the decision about whether to produce a new product. Its performance might be factors in its favor, while its very high cost, might be factors against it. These factors, criteria and considerations may be entered directly or obtained from data bases of predictive factors for the type of situation being examined. The smart start procedure, if used, may suggest various specific factors that should be considered. However, the user might likely add additional factors or change factors, if pertinent to the specific situation. FIGS. 5-7, portraying an exemplary user interface 30 employable in the above procedures, at column 52, illustrates various factors for a given situation, where the first decision is illustrated by a first decision alternative, i.e., “Merge with Cargill”.

Once factors are determined or suggested, and accepted by the user, a next step may be to weight the factors or criteria noted above for their importance on some numerical or other scale. See, e.g., column 54 in FIGS. 5-7. For example, if the price factor is important, it might receive a weight of High to reflect that it is a highly important consideration in the decision. The weighting might be input numerically or in the preferred representation by symbol: Low, Medium, High or Extremely High. The system may then transform any symbolic entry into a numerical value via a user-generated or default table. The criteria may have other data associated with it such as importance, date of origination, priority, and so on, and these may be used to adjust the numerical value of the symbolic entry. For example, criteria based on more recent data may be given more weight than older data. For each criterion and its corresponding scale, the same may be re-scaled to a measure of probability, in which case the numerical values for each alternative-criterion pair may then be interpreted as a probability.

As noted previously, the next step is the entry of one or more decision alternatives for consideration (step 14 in FIG. 4). In FIGS. 5-7, a first decision is given in column 58, and is a trial decision to “Merge with Cargill”. Alternative decisions may be entered (step 17) and placed in sequential adjacent columns to that of “Merge With Cargill”.

After the alternatives are entered, ratings are entered, that is, the alternatives would then be rated on each of the criteria (see weighting column 58 in FIGS. 5-7). This rating may be done in a matrix, grid, tabular form or through an appropriate software wizard. In one exemplary embodiment, the alternatives may be given in columns and the criteria may be given in the rows. The cells in the grid then may have the ratings for each alternative-criterion pair. These are then translated into numbers, depending upon the weighting of the criterion.

In more detail, a specific rating may then be associated with each alternative and each factor (column 58 in FIGS. 5-7). The rating would specify to what degree the factor supported the success or correctness of that alternative, or to what degree the factor would impair or harm the success of that alternative. The ratings might be numerical or symbolic. For example, a double plus would indicate that the factor strongly supported the success of the corresponding alternative. As an example, low price might strongly support the success of a given new product. The various ratings would then be transformed into conditional probabilities by the systems and methods according to present principles. Those conditional probabilities would then be employed to predict the success of the alternative, which may be a quality metric as illustrated by element 56 in FIGS. 5-7.

At the end of the data entry phase, then, the following will have been entered into the grid: the various alternative decisions; the criteria or factors used to rate the different alternatives, along with their weightings; and the ratings themselves, where any non-numerical rating may have been transformed into numbers.

In some cases, a similar data entry phase may be employed as that described in the above referenced patent with the following differences: The factors or criteria employed typically focus on the drivers of success or achieving of the decision result or its successful accomplishment. That is, the predictors of the decision's success or lack of success, or its correctness as the right choice, may be determined in this way. The smart start may assist in identifying those more relevant factors. The inclusion of an additional weighting value, Extremely High, meaning this is a factor that is critical to the success of the decision, a consideration that virtually has to go right for the decision to succeed or achieve its objectives or be the right choice.

### Calculation of Metrics for Quality and Probability the Decision Alternative is Successful

The systems and methods according to present principles are then employed to examine this trial decision, and various metrics or performance measures are calculated about the trial decision (step 16). These metrics would examine the decision's quality, value in achieving the goals, probability of being successful, level of risks, level of black swans or other issues pertinent to the decision being considered successful, useful or pertinent, including potential risks, biases, missed consideration and surprises.

If the determined quality metric of the first decision indicates that the first decision already meets or exceeds a goal metric (which may be entered in step 15), then the process may be ended (step 19) and the first decision used as the basis for action (i.e., a final decision). If however the metric is below the threshold, then the step may be performed of determining a revised decision (step 18). Many sub steps may be taken as are described below. Once the steps are taken, a revised decision may be formulated, and a calculation of the quality metric of the revised decision may be performed (step 22). If this metric is below the goal, the steps may be repeated. If the metric meets or exceeds the goal, the process may again be ended.

Goals for the metric tend to provide a powerful motivation to improve the decision. For example, suppose the quality metric, the probability of success, has a goal of 90%. That level of goal turns out in practice to be highly challenging to achieve. Since most decisions start out below that 90% level, the users then strive to improve aspects leading to the decision.

In order to improve the decision, the system and methods expose certain aspects and issues of the decision that might be improved. Issues exposed might be potential risks or black swans, or they might be questionable assumptions or biases that might be revised and corrected, or they might be new opportunities the decision should exploit. These suggestions made by the systems and methods are then employed by the user to improve the decision.

The systems and methods according to present principles are able to suggest considerations to improve by statistically analyzing the information. Outliers and other anomalous or inconsistent information are often signals that something is awry, possibly a risk that has been missed and should be examined. By statistically identifying that information, the systems and methods point to how to improve the decision.

In more detail, a next step is the calculation of metrics for the quality of the decision alternative or the probability that this decision achieves its goal or objective or is the correct decision to make. For alternative decision j let Pj be that probability.

Assume there are m rows of factors or criteria that were entered. Also assume that there are n alternative decisions, where n=1 is permissible. Now consider the rating for factor i and decision alternative j. Define Rij as the numerical rating value for factor i and alternative j, which is the conditional probability. Also let N be the numerical value of Neutral, the rating if a particular factor i has no or a neutral impact on the alternative j.

Then define

Prodj=Π_{i=1, . . . , m} Rij

as the product of all the numerical rating entries in the column for alternative j.

Then define Pj, the probability of success of alternative j as

Pj=Prodj/(Prodj+N^{m})

This expresses the probability alternative decision j is successful or achieves its objectives or is the right choice. Its calculation employs two major considerations: First, the conditional probability of all of the m factors on which success depends. Secondly, that is compared to a general but non-specified other decision that might occur. This calculation for Pj is the result of a Bayesian analysis. Other means for this calculation can also be employed including empirical, judgmental, or formulae that disregard other alternative decisions or evaluate them differently. The net result is that Pj is the chance alternative j will be successful or is the right choice.

Pj provides a critical metric and is calculated quite differently than, e.g., in the referenced patents. That is because, in one implementation, systems and methods according to present principles are generally concerned about the probability alternative j is right, meaning in an absolute sense of the probability alternative j is successful. In the referenced patents, the calculation in most implementations generally provides the relative probability, relative to the other alternatives. However, it is noted that systems and methods according to present principles generally permit either calculation to be examined. Such enables the user to obtain the information from either calculation, should that be desired.

The metric for the quality, probability of success is also the basis for the valuation metrics, such as the financial valuation. Systems and methods according to present principles create an expected financial value by adjusting the financial value by the probability of success. That provides an expected valuation.

### Metrics for the Probability of Surprise/Missed Issues and Black Swans

Next is an exploration of the metrics that estimate the chance of missed issues, be they surprises, risks, black swans or other considerations that have not be considered or have been missed. The calculation for the probability of surprise or missed issues may be similar to those in the referenced patents. Systems and methods according to present principles may extend and build upon that calculation in several ways:

One is that the probability of surprise is compared to the chance of the most likely or other specified alternative. This provides an estimate of the surprise in a relative sense. If surprise is high relative to the chance the best alternative is successful, then that suggests surprise is a major concern.

A second value is the identification of unknown-unknowns as black swans. This provides a logical means to estimate the probability of black swans. That is obtained as follows: The probability of missed issues and surprises is identified as the probability of the unknowns. At this point the same calculation is done but on the unknowns. That provides the probability of the unknown-unknowns.

In other words, first the relevant universe is divided into known and unknowns. Then the unknowns are focused on and they are divided into knowns and unknowns. The result is known-unknowns and unknown-unknowns. The unknown-unknowns are the “black swans”.

To clarify, systems and methods according to present principles first consider the total relevant universe and estimate the chance of the unknowns in that total universe. Then they consider the unknowns as its universe (actually a sub-universe). They then estimate the chance of the unknowns in that sub-universe, which is the unknowns of the unknowns, or unknown-unknowns. But the unknown-unknowns are the black swans.

At this point the metrics for the quality of the decision and the various metrics for surprise in its different manifestations have been determined. Now, the user examines their values. Typically, one wants the various metrics for surprise, issues missed, and black swans to be low.

Typically goals might be given for those metrics. The goal for the quality metric might be 90%, although in practice, that level is very difficult to achieve. Similarly, the surprise value might be under 10% although that might be difficult to achieve.

The user may then examine the metrics to determine how good are the possible decision alternatives. Is any decision alternative really performing well on the metrics, say surpassing the goals? If so, the user might select that alternative as the decision.

More often, no alternative decision is deemed sufficiently good. Hence, it is necessary to improve the decision, to identify ways to enhance the decision or to develop an entirely new decision that is superior.

### Examination of the Present Analysis and Improvement of the Decision

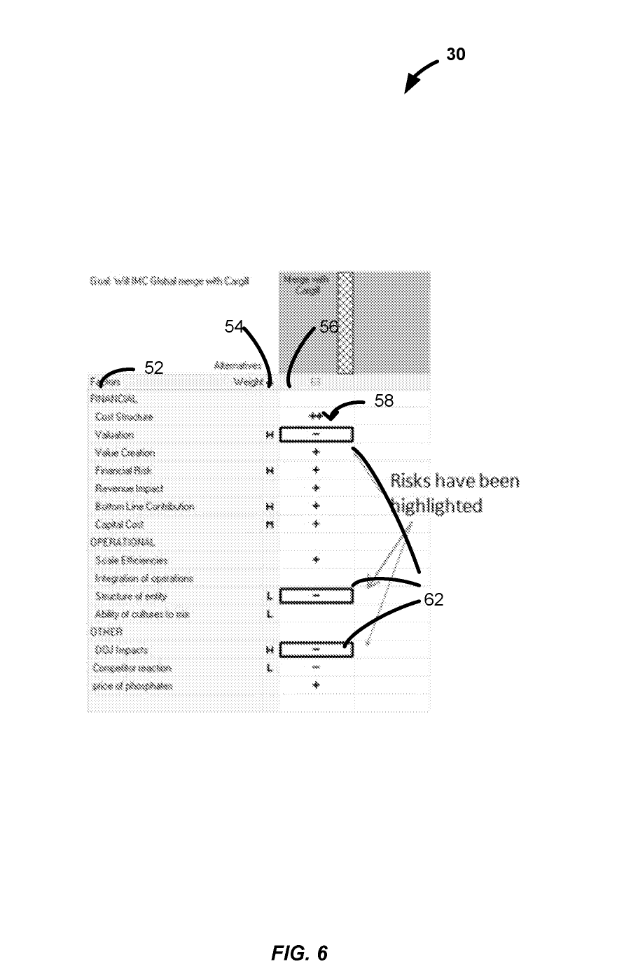

Assume the decision needs to be improved, which is the usual situation. The first action is to use the systems and methods according to present principles to highlight rating cells that might suggest ways to improve the decision. See, e.g., highlighted cells 62 in FIG. 6. Here are a non-limiting list of various analyses that can be conducted by certain systems and methods according to present principles:

POTENTIAL RISK AND BIASES. Assume there are one or more alternative decision choices or options, and they are indexed by the letter j, j=1, . . . n, where n is the total number of choices.

The ratings for alternative j are examined. These are listed in column j and correspond to what degree factor or criteria i is predictive of the success of alternative j. These are the numerical values of Rij. The systems and methods according to present principles may then identify several of the lowest or smallest Rij in column j. These correspond to the factors that support alternative j the least or worst. They might suggest that alternative j is not a good choice or that alternative j might fail. They tend to reflect possible risks for the alternative j decision.

These risks should be examined first to determine their validity. But further, to identify means to ameliorate, counter or prevent them, at least to some degree. Taking steps to counter the risks will improve the decision.

Potential confirmation bias or possible strengths of the decision alternative j. These are the ratings in column j that are highest, or close to highest. The first question to be examined by the user is if these ratings reflect overconfidence or confirmation bias. Humans are known to overemphasize positive aspects of their preferred belief. If so, that must be corrected. Or these ratings might not be biased and be accurate, and in that case these ratings might reflect the strengths of that alternative decision. If so, then they might be strengthened even more. The user then might try to seize those opportunities that have been highlighted.

Potential dangers for alternative j. There are the factors i where other decisions are stronger and have higher ratings for that factor. Why are these other decision alternatives stronger in those factors? Can these other decisions beat alternative j on those aspects? That represents potential dangers, and the user should take steps to counter those dangers.

Negative bias. Humans often have a negative bias against beliefs or actions with which they have some disagreement or that are against what they want to do. Humans sometimes deliberately downplay the other opinions or beliefs. Systems and methods according to present principles may examine the ratings outside of column j to determine what ones are especially negative and then highlights them. The user should examine them to identify any negative bias and then change that if such are identified.

With these operations, systems and methods according to present principles identify potential risks, various possible biases, as well as possible opportunities. The user is then enabled to take steps to counter the problems and take advantage of the opportunities. This then leads to an improved decision or possible an entirely new approach or new decision alternative.

### Test and Improve a Decision

The quality or effectiveness metric opens up the possibility to test a given decision. Specifically, suppose there is a trial decision one wishes to test. One enters the information about it and rates it on the success factors. The corresponding quality or effectiveness metric then immediately provides a numerical value for that trial decision. Suppose the metric value is 62%. In some cases that might be adequate, but it is significantly under a 90% goal for an outstanding decision.

At this point the various capabilities of the systems and methods can be utilized to improve the decision, hopefully, getting it closer to the 90% performance level. For instance, risks and biases might be identifies and attacked. Or the list of suggested breakthroughs might be examined for ideas. The net result should be a decision better than what one started with.

The point here is the capability to test a decision and seek to improve it. This is in contrast to the usually discussion process where individuals discuss and have no systematic and more objective means to evaluate and improve the decision.

### Financial Analysis

Traditional financial projections forecast various financial values and from that information, estimate the financial value. The invention suggests another means to conduct that valuation, more in the realm of comparables. But it also permits the decision to be improved, which should raise its financial value. Conceivably, the decision might be improved to become an outstanding or breakthrough decision that would have quite high value.

The invention compares the given situation to other reference situations. Depending upon its proximity to the reference situations, that suggests that the situation being examined would have a similar valuation. Interpolation may be employed. That might be adjusted for changes in circumstance, but the basic calculation is founded on the degree of similarity to various reference situations.

Valuation: The financial or other valuation could also be obtained. Typically, two references would be given whose valuations would be known or, at least, user estimated. How close the present situation is to either of the two references, would determine its valuation, as noted in greater detail below.

### Iteration

The improved decision then starts another iteration of the process, with the improved decision becoming the new trial decision. As before, the systems and methods then examine this new trial decision to determine its metric values. If these metric values are still not sufficiently high, the systems and methods again suggest issues to improve. A further improved decision is then developed. This improvement process continues perhaps for several iterations until the metrics achieve a sufficiently high level that suggests that the decision would be excellent, possibly, a breakthrough. If so, then the user should be able to make the final selection at this point. If not and the metrics are still not good enough, the iterative improvement process is conducted again.

For example, in the situation illustrated in FIGS. 5-7, certain risks were seen in the ratings associated with the decision to “Merge with Cargill”. These were identified by the highlighted cells 62 in FIG. 6. An improved decision (seen by the elements in column 66) shows an improvement in the decision, e.g., in the overall quality metric illustrated by element 64, where the metric is seen to increase from 67 to 80. The improved decision was enabled by the analysis of metrics step, in which a turnaround or counter to the valuation risk was enabled by consideration of a joint venture of a portion of the business with Cargill rather than an outright merger. This alternative decision also saw an increase in an operational factor, i.e., integration of operations, which was not particularly identified as a risk before.

By following the systems and methods according to present principles, the user may determine a superior decision or at least an improved version of a decision alternative. This becomes a new trial decision. Following basically the steps of the initial data entry presented above, the user enters into the grid or other realization of the systems and methods the new trial decision. Perhaps some factors may have to be changed or added. Columns might have to be added or changed. But such enables the trial decision to be examined and tested.

### Additional Aspects

As part of examining the quality or excellence of the decision at any iteration of the process, for many decisions it is useful to determine its estimated financial valuation or other metric of the decision's value or benefit. Green and Armstrong noted that the accuracy of a decision was improved if situations analogous to the decision being examined were considered in the analysis. These analogous situations served as references. Systems and methods according to present principles in part extend this work by incorporating a metric for the financial or other value or benefit. The metric permits a valuation of the references as well as of the situation under consideration.

Systems and methods disclosed here may be employed with one or more references, but two seems in many cases most convenient.

The systems and methods utilize a metric on the references. Typically there will be two references, one with a high metric, typically a high financial value, while the other might have a more modest or lower valuation, that is, a lower financial value. By comparing the given situation to the references, the systems and methods determine how close the situation is to the different references. If the given situation is closer to the high reference, the situation would receive a higher valuation. Analogously, if the situation is nearer the lower reference, it would receive a lower valuation. The systems and methods calculate where the situation is relative to the two references, and that determines its value.

How close the situation is to one or the other reference is calculated by examining the underlying factors that predict the valuation. With a new product, for example, the financial value might be estimated by considering factors such as: market size, how different the product is from the competition, customer response to early testing, price relative to competitors, effectiveness of branding, etc.

The high reference, representing a successful situation, would receive a high rating on those factors. The lower reference, being less successful, would receive a lower rating on those factors. The present situation would then be rated on those factors, and depending how the present situation rates on those factors, would determine which reference it were closer to, the high reference or the low one. That permits the valuation of the situation to be estimated. The higher the ratings on the underlying factors, the closer it is to the high reference and the higher the valuation of the present situation.

Although it is helpful to have references from actual situations, hypothetical references can be employed.

Example Valuation Calculation: To illustrate the underlying concept suppose there are two references, the one of high financial value has a valuation of 200. The one of lower valuation has a value of 100.

Systems and methods according to present principles, after rating the underlying factors, may determine that the high reference has a quality of 80%. The lower reference has a quality rating of 40%.

The systems and methods may then determine the quality rating of the situation being examined, again by evaluating its underlying factors. Suppose that quality is 60%. Then the financial value of the given situation is estimated at 150.

Risk Consideration: Once the value of the present situation is estimated, the impact of the underlying factors on the valuation may be obtained. The systems and methods may examine the impact on the valuation of any individual factor. That reveals information about what factors are most important in determining the valuation and also the risks. Factors that are weak or harming the value, might be risks. Those factors can then be highlighted, and, presumably, improved.

### Improvement

At this point the invention would help identify various risks and biases in the decision. Doing that might improve the decision and raise its quality to 70%, yielding an estimated financial value of 175. An examination of the breakthrough ideas might lead to even further improvement, say to 80% on the metric for a value of 200. Yet another iteration and examination of the risks might produce an even higher financial value say 220.

Confirm the Valuation Process: Another capability of systems and methods according the present principles is to test the valuation process. For that a third reference with known valuation is considered. The systems and methods then independently predict the valuation of that third reference. If that prediction accurately predicts the known value, such tends to confirm that the various parameters and factors have been set properly. Traditional valuation means lack this capability of easily testing the process on a situation with known value.

The financial analysis thus has the following steps:
1. Determine References and Their Valuation. Given the decision situation, consider one or more reference situations, that is, situations similar or analogous to the given situation being considered. These might be situations for which the valuation is known or hypothetical ones where the user can estimate the valuations. Generally, two references are most convenient.
2. Specify the valuation of the references.
3. Next, specify the factors that underpin and determine the valuation. These factors are largely responsible for the difference in outcomes between the high reference and the low reference. For new product, these might be factors such as: degree of difference from competitive product, price relative to competitors, distribution level to retailers, clever or memorable advertising, low cost of production, and the like.
4. Rate the references and the given situation on those factors. The high reference would generally rate high on virtually all of those factors, and the low reference, on the other hand, would rate lower on many of the factors.
5. The systems and methods may then determine how close the given situation is to either of the references. The proposed project under consideration may be evaluated in this way by considering the various factors. How well, from low to high, is the proposed project expected to perform on each of those individual factors? That will determine its estimated valuation (other metrics, including ROI, can be similarly analyzed). The effectiveness of the overall project and creating financial value is determined by how effectively each of the underlying factors does its job in building financial values. Hence, rating the underlying factors allows the prediction of the effectiveness of the overall project in creating financial value.
6. Risks: By examining the impact of each factor on the total valuation, the factors that were most important to the valuation, and also those that are risks, can be determined.
7. Validation. If desired, using a third, independent reference with known valuation, the process can be tested to determine if it predicts that known valuation accurately. That testing can be used to adjust the parameters and factors as necessary.

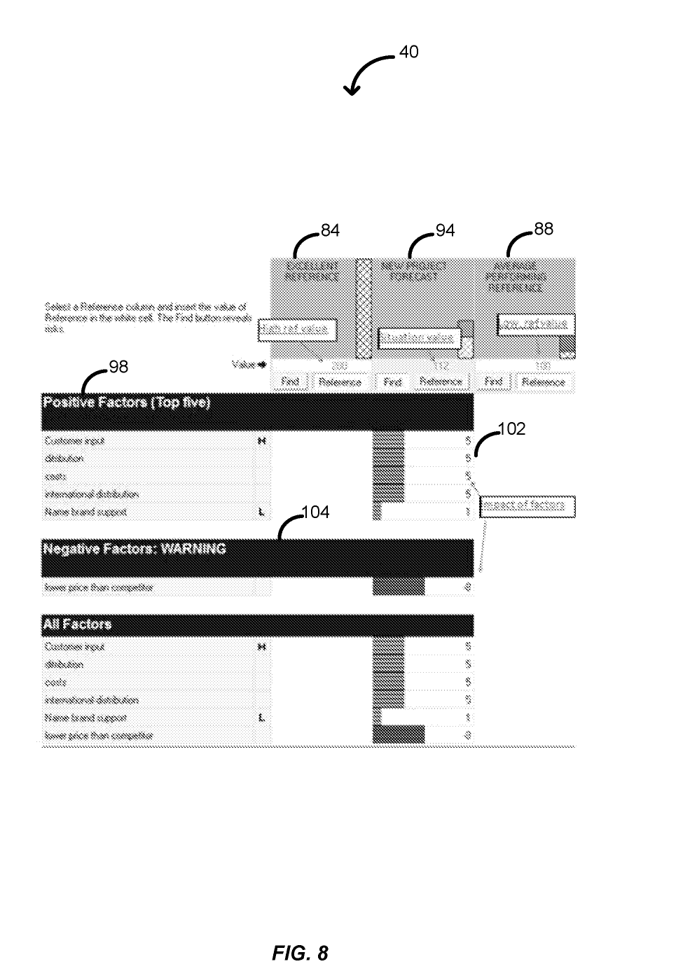

As a specific example, and referring to the exemplary user interface 40 portrayed in FIG. 8, a value of a high reference 84 is 200. A value of a low or modest reference 88 is 100. The situation being examined, e.g., a new project, is shown by element 94. This situation was determined to be closer to the more modest reference by examining the underlying factors that predict success. In particular, its valuation was determined to be 112. The value factors and their valuations provide the importance of the factors and how much they help or hurt the valuation. Customer input, for instance is 5. Lower price than competitors, however, is a risk and harms the valuation by −8, in other words, the price is not lower than the competitor's, meaning that price is a liability. While there were more positive factors 98, the weighting 102 on the negative factor 104 was such as to override the positive factors and bring the new project closer to the more modest reference value.

One advantage of the above methodology is that the same automatically reveals the impact on the financial performance of the different underlying factors.

The relationship between this approach and comparables is apparent. Traditionally under the comparables approach firms are examined similar to the one under consideration. Their financials, perhaps with some adjustments, are then employed as guidance as to what the firm under consideration should be worth. The comparables methodology is widely utilized in valuing real estate, acquisitions, estimating stock price, company valuation and so on.

The approach here differs from the more traditional comparables methodology in various ways.

First, what is sought is to examine the underlying causes of the financial numbers. If considering revenues, underlying factors might be considered that create the revenues such as market share, competitive advantages, distribution network, consumer base, brand loyalty, etc. By considering the causes underpinning the financial performance, that should help better understand and predict that performance.

Second, a high reference and a low reference are posited. That provides a contrast. On what underlying factors does the high reference beat the low factors? That provides information on why the high reference is performing better. Those factors then become useful to consider carefully.

Third, it becomes easier to improve the financials because weaknesses can be identified in certain underlying factors. It might be discovered, for example, that a sales network is not as effective as it might be. That opens an opportunity to improve that factor and boost the financial valuation.

Fourth, this methodology is more easily employed on the project level when comparable financial data are difficult to obtain. A high performing reference and a low performing reference can be posited and then the differences between the two may be considered on the underlying factors. Where the project fits between those references, provides a valuation for our project.

Fifth, the software automatically calculates critical information. It estimates the overall financial effectiveness by aggregating the financial impact of the underlying factors, employing a Bayesian analysis. This not only provides financial valuation but the impact on that valuation of each underlying factors. Factors that do especially well, might signal opportunities . Weak factors might indicate risks. That information is automatically created by testing the impact of the individual factors.

### Cross-Check Procedures

The technique discussed herein also permits procedures to cross-check aspects of financial projections.
1. Given a projection done with the traditional financial procedures, the techniques herein provide a convenient means to independently cross-check the results.
2. The accuracy of the technology herein can be cross-checked by having it predict the financial value of a situation with known financial value.
3. Some of the numbers generated by the technology herein can be cross checked as they are developed . For example, a high reference may be valued at $200 million with a 90% efficiency. A lower reference may have a 30% efficiency. The valuations should be roughly proportional since they reflect the strength of the underlying factors. Note that 30/90 times $200 million is approximately $66.7 million. That is very close to the value of $70 million for the value of the low reference. Hence, these numbers are reasonably consistent.

The approaches used by systems and methods according to present principles are much faster than the traditional and can be undertaken with a minimum of financial background. It is not necessarily meant as a substitute for the traditional approach but permits valuation to be undertaken by a much broader base of individuals on a much broader base of projects.

It also operates from a different foundation, as it is based upon the underlying factors that produce the financial results. It examines the primary causes of valuation. This permits exploration of risks and easier development of means to improve the activity, strategy or project. Moreover, the underlying causes of the financial valuation are immediately seen, and that helps to understand and improve results.

In this manner, systems and methods according to present principles to not just estimate financial value, but provide a means to improve that valuation.

In certain implementations, the above description allows a highly different concept in making decisions. In the traditional approach, which is been relatively unchanged for thousands of years, information is gathered, examined, discussed, and finally used to make a decision. Systems and methods according the present principles in certain implementations may be employed to, instead, of waiting until the end and making one big decision, the user makes several trial or test decisions fairly quickly that build to better and better decisions. It is the difference between trying to leap as high as the user can, versus taking the stairs. The user gets higher, faster with the stairs.

With the higher, fast methodology, to make the decision, information is gathered and examined, but decisions are made quickly. Now, what is important is that the decisions are tested and determined for what has to be improved. The improvements are made, and the improved decision is tested again. Two or three iterations of this with the fast testing, fast feedback and fast improvement, typically creates a better decision faster.

Such an approach promotes better decisions with less risk. Tests using this methodology performed by the inventor at the University of Chicago confirm this, as, on average, the participants stated their decisions were 40% better and 20% faster. The fast testing concept has also been highly successful in agile software development, rapid prototyping and lean start-ups. The fast testing and reiterations permit faster learning, and as mentioned, more fit the model of great decisions. And contrary to conventional wisdom about proceeding quickly, risks are not missed, but rather they are located in a more systematic manner, allowing more systematic countermeasures. In fact, the software helps unveil hidden risks, as well as other statistical dangers such as biases or the like.

It should be noted that while the above description has been made with respect to specific embodiments, the scope of the invention is to be interpreted and limited only by the scope of the claims appended hereto. For example, while a Bayesian analysis has been described, any number of probabilistic methods may be employed to yield results, including: neural nets, data mining, simple probability algorithms, and various other such methods. It should also be noted that the above descriptions has used the terms “system” and “method” in an exemplary fashion, and these refer to system embodiments and method embodiments of the invention. The use of one such term does not exclude consideration of the other with respect to the described and pertaining embodiment. The term “software” is also used on occasion to mean either “system” or “method”, depending on context.

The system and method may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, are loaded into random access memory. Inputs to the application, e.g., from the plurality of users or from any one user, may be by any number of appropriate computer input devices. For example, users may employ a keyboard, mouse, touchscreen, joystick, trackpad, other pointing device, or any other such computer input device to input data relevant to the calculations. Data may also be input by way of an inserted memory chip, hard drive, flash drives, flash memory, optical media, magnetic media, or any other type of file-storing medium. The outputs may be delivered to a user by way of a video graphics card or integrated graphics chipset coupled to a display that maybe seen by a user. Alternatively, a printer may be employed to output hard copies of the results. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., personal computers, laptop computers, notebook computers, net book computers, handheld computers, personal digital assistants, mobile phones, smart phones, tablet computers, and also on devices specifically designed for these purpose. In one implementation, a user of a smart phone or wi-fi-connected device downloads a copy of the application to their device from a server using a wireless Internet connection. An appropriate authentication procedure and secure transaction process may provide for payment to be made to the seller. The application may download over the mobile connection, or over the WiFi or other wireless network connection. The application may then be run by the user. Such a networked system may provide a suitable computing environment for an implementation in which a plurality of users provide separate inputs to the system and method. In the below system where decisions are contemplated, the plural inputs may allow plural users to input relevant data at the same time.

1. A modular system for decision-making and analysis with the goal of making better decisions than might have been made, and obtaining more outstanding or breakthrough decisions, comprising:
a. a repository or collection of apps or subprograms, each app for a different type of decision, and configured to provide background and information that would help make a decision of that type better;
b. a breakthrough engine for making the actual decision, designed to utilize data from the repository; and
c. a user interface to allow a user to update information in an app, such that future uses of the app result in decisions of higher quality, thereby creating an adaptive decision-making process.

2. The system of claim 1, wherein the app includes information relevant to making the type of decision, the information including:
a. one or more success factors, wherein the success factors are criteria to be considered in making a successful decision; and
b. one or more breakthrough ideas or insights, the breakthrough ideas or insights, suggestions of how to make the decision a breakthrough decision, wherein a breakthrough decision is one having a quality metric exceeding a predetermined threshold.

3. The system of claim 1, further comprising an user interface or API for crowd sourcing, such that users are enabled to add or edit data in the repository or collection of apps or subprograms, whereby the same is kept up-to-date and with important information relevant to making a decision successful, and further comprising:
a. a user interface for reviewing and refereeing data from the user interface for crowd sourcing; and
b. a security module for controlling access for users to the user interface for crowd sourcing.

4. The system of claim 3, further comprising a user interface configured to display information about the identity of users to the user interface for crowd sourcing, and providing a means to communicate with such users.

5. The system of claim 1, further comprising a user interface whereby users to the user interface for crowd sourcing are enabled to rate and comment on apps, whereby the value of different comments and contributions to the apps may be conveniently displayed, and contributions be rewarded or recognized.

6. An iterative method of decision-making and analysis, comprising:
a. receiving a first decision;
b. performing a calculation of a weakness or strength of the first decision, or both;
c. performing a calculation of a quality metric of the first decision;
d. if the quality metric of the first decision is below a predetermined threshold, then determining a revised decision based at least in part on the calculated weakness or strength or both;
e. performing the calculation of the quality metric on the revised decision; and
f. if the quality metric of the revised decision is below a predetermined threshold, then performing a calculation of a weakness or strength on the revised decision, and determining a new revised decision based at least in part on the calculated weakness or strength or both of the revised decision, and if the quality metric of the revised decision is at or above the predetermined threshold, then determining the revised decision to be a final decision.

7. The method of claim 1, wherein the quality metric is a likelihood of success.

8. The method of claim 1, wherein the quality metric is excellence.

9. The method of claim 1, wherein the performing a calculation of a weakness or strength of the first decision or the revised decision further comprises:
a. entering one or more alternative options into a database;
b. for each of the alternative options, entering at least one criterion or factor for evaluating the alternative option;
c. specifying a relative importance of each of the criteria or factors;
d. specifying, for each alternative option, a strength rating, wherein the specifying a strength rating indicates how well the criteria or factor either supports the option or opposes the option; and
e. calculating a result for each alternative option based on the relative importance and strength rating.

10. The method of claim 9, further comprising providing one or more metrics for the quality, excellence, and likelihood of success of any of the alternative decision options, the metrics based upon underlying factors that will determine the alternative option's success.

11. The method of claim 10, further comprising establishing one or more goals for one or more respective metrics.

12. The method of claim 11, wherein if no alternative option has a goal that is met or exceeded by its respective metric, then performing another iteration of the process.

13. The method of claim 10, wherein the metrics include metrics for the weaknesses of the decision, including risks, issues missed, and surprises.

14. The method of claim 9, further comprising analyzing the alternative options to determine overconfidence, confirmation, or other positive bias, by statistically identifying ratings that are outliers or excessively high in comparison with other ratings, and revising identified ratings or alternative options in response thereto.

15. The method of claim 9, further comprising analyzing the alternative options to determine negative bias or efforts to discount or downplay alternatives that are considered undesirable, by statistically identifying ratings that are unusually low or weak in comparison with other ratings, and revising identified ratings or alternative options in response thereto.

16. The method of claim 9, further comprising analyzing the alternative options to identify surprises or threats against any particular alternative, by analyzing where there are ratings that are stronger than comparable ratings for a given alternative, and further comprising calculating means to counter such identified surprises or threats.

17. The method of claim 9, further comprising analyzing the alternative options to identify risks against any particular alternative, by analyzing where there are ratings that are weaker or lower relative to other ratings for that alternative, and further comprising calculating means to counter or overcome such identified risks.

18. The method of claim 1, further comprising:
a. formulating one or more new alternative decisions;
b. testing an effectiveness of the one or more new alternative decisions; and
c. testing the one or more new alternative decisions to determine to what degree they might improve the overall decision.

19. The method of claim 1, further comprising receiving input from one or more users acting as critical decision-makers, whereby the final decision is improved by receiving input from multiple parties.

20. The method of claim 1, further comprising, in response to input from a user about the type of decision, generating a list of one or more factors or issues suggested to be appropriate for consideration in that type of decision, and receiving input from a user corresponding to at least one of the generated list.

21. The method of claim 20, further comprising generating default ratings for the generated list of one or more factors or issues, the default ratings generated by a method selected from the group consisting of: user input, a frequency with which the factor or issue was selected in the past, an importance given to the factor or issue in the past, information on how relevant the factor or issue was in determining a correct decision in the past, or combinations of the above.

22. The method of claim 1, further comprising receiving and storing comments from users about how to make a decision and what aspects to examine more carefully.

23. The method of claim 1, further comprising receiving a financial, benefit, or other metric valuation, further including:
a. receiving information about one or more reference alternative options, each of the one or more reference alternative options associated with a value; and
b. determining how close an alternative option is to the one or more reference alternative options; and
c. valuing the alternative option based on how close the alternative option is to the one or more reference alternative options, and the respective values of the reference alternative options.

24. The method of claim 23, wherein two reference alternative options are provided, a high valuation reference alternative option and a low valuation reference alternative option, and further comprising evaluating each of the two reference alternative options for underlying factors that predict success, where the high valuation reference option has a high probability of success, and the low valuation reference has a a low probability of success.

25. The method of claim 24, further comprising analyzing a current situation by analogizing the current situation to its closeness to the high valuation reference alternative option and the low valuation reference alternative option.

26. The method of claim 20, further comprising determining an impact of the factor or issue on a valuation of a current situation, by removing a factor or issue from a valuation analysis and determining the change in the valuation due to the absence of the factor or issue, whereby the importance of the factor or issue may be determined, such that factors or issues that have a major impact on improving a valuation would be highly important to that valuation, and factors that are weak or harmful might be identified as risks.

27. A non-transitory computer readable medium, comprising instructions for causing a computing environment to perform the method of claim 1.

28. An iterative method of decision-making and analysis, comprising:
a. receiving a type of decision;
b. determining one or more factors bearing on the type of decision;
c. determining a first decision;
d. rating the determined one or more factors with respect to the determined first decision;
e. determining a quality metric of the first decision;
f. if the quality metric of the first decision is below a predetermined threshold, then performing an analysis of the first decision and the determined one or more factors to determine a revised decision;
g. performing the calculation of the quality metric on the revised decision; and
h. if the quality metric of the revised decision is below a predetermined threshold, then performing an analysis of the revised decision and the determined one or more factors to determine a new revised decision, and if the quality metric of the revised decision is at or above the predetermined threshold, then determining the revised decision to be a final decision.
